(19) United States
(12) Patent Application Publication
(10) Pub. No.: US 2024/0318003 A1
(43) Pub. Date: Sep. 26, 2024

(54) COMPOUND USING NATURAL PIGMENT

(71) Applicants: DIC Corporation, Tokyo (JP); National Institute of Advanced Industrial Science and Technology, Tokyo (JP)

(72) Inventors: Takahiko Ootsubo, Sakura-shi (JP); Hitoshi Sekine, Sakura-shi (JP); Atsushi Yamamoto, Tsukuba-shi (JP); Koji Nemoto, Tsukuba-shi (JP); Masaru Yoshida, Tsukuba-shi (JP); Masanori Tamura, Tsukuba-shi (JP)

(73) Assignees: DIC Corporation, Tokyo (JP); National Institute of Advanced Industrial Science and Technology, Tokyo (JP)

(21) Appl. No.: 18/574,192

(22) PCT Filed: Jun. 20, 2022
(86) PCT No.: PCT/JP2022/024448

§ 371 Date: Dec. 26, 2023

(30) Foreign Application Priority Data
Jul. 6, 2021 (JP) 2021-112095

(51) Int. Cl. C09B 61/00; C09B 67/14; C09D 7/41; C09D 11/037; G03G 9/09

(52) U.S. Cl. CPC C09B 61/00; C09B 67/0017; C09D 7/41; C09D 11/037; G03G 9/09

(57) ABSTRACT

Provided is a compound with a high biomass ratio (preferably a compound with a biomass ratio of 100%) obtained by using a natural pigment and having excellent color developability and light resistance. The compound is a compound in which a natural pigment of curcumin is bound to an organic acid has a number average molecular weight (Mn) of 400 to 4,950.

### TECHNICAL FIELD

The present invention relates to a compound using a natural pigment.

### BACKGROUND ART

In recent years, the construction of a sustainable society (sustainability) has been increasingly required in consideration of the global environment, ecosystems, social economy, and the like. In the printing industry, the avoidance of a fossil resource is also desired. For example, in consideration of the global environment, living organisms, safety, and the like, no use of toluene has been facilitated in the production of a printing ink. From the viewpoint of carbon neutrality, interest in replacement of a raw material used in the production of a printing ink by a chemical derived from biomass increases, and studies on the production of a solvent and a resin contained in a printing ink from a biomass material are active.

Although environmental consideration is also made in the printing industry as described above, only the production of a solvent or a resin derived from biomass is achieved, and the production of a pigment derived from biomass is not achieved.

As a pigment used as a coloring material for a printing ink, a lake pigment obtained by making a dye insoluble with metal ions is widely used since it is excellent in color developability and light resistance.

In production or purification, metal ions are discharged during drainage, and therefore a method for making a dye insoluble with metal ions requires a separate drainage treatment process or the like to remove the metal ions. It is believed that the separate drainage treatment process can decrease an influence on the environment.

However, due to an increase of recent consumer awareness of a product considering the global environment and ecosystems, production by a method that is less likely to affect the environment is required in the pigment field. That is, the development of a pigment that is produced without metal ions and that can ensure the prevention of the discharge of metal ions is desired.

As the pigment produced without metal ions, for example, an organism-derived pigment, such as a pigment using alga as it is, is reported (see Patent Literature 1).

### CITATION LIST

### Patent Literature

Patent Literature 1: U.S. Patent Application Publication No. 2015/0240093

### SUMMARY OF INVENTION

### Technical Problem

Since the pigment described in Patent Literature 1 contains an organism-derived pigment produced without metal ions, the pigment has less environmental impact. However, since alga is used as it is in the pigment, the pigment has such a problem that the selectivity of color tone is low.

The pigment described in Patent Literature 1 has lower color developability than a conventional lake pigment obtained by making a dye insoluble with metal ions.

For use as a colorant for an ink, a toner, or a coating material, it is necessary to meet various characteristics required as a coloring material, such as color developability and light resistance. So far, from compounds with a high biomass ratio using natural pigment (for example, a pigment), a compound having excellent color developability and light resistance is not provided.

An object of the present invention is to provide an environmentally benign compound using no metal, and particularly a compound with a high biomass ratio (preferably a compound with a biomass ratio of 100%) obtained by using a natural pigment and having excellent color developability and light resistance.

### Solution to Problem

The inventors of the present invention have intensively studied to achieve the object, and as a result found that the object can be achieved by a compound in which a specific natural pigment such as curcumin is bound to an organic acid. Thus, the present invention has been completed.

Specifically, the present invention includes the following aspects.
[1] A compound in which a natural pigment of curcumin is bound to an organic acid, the compound having a number average molecular weight (Mn) of 400 to 4,950.
[2] A compound in which at least one or more types of natural pigments selected from alizarin, carminic acid, lac dye or laccainic acid, capsanthin or capsicum pigment, Safflomin or Carthamus yellow pigment, shisonin or Perilla pigment, and Xanthomonasin or Monascus pigment is bound to an organic acid.
[3] The compound according to [1] or [2], wherein the organic acid has at least one or more carboxylic acid groups.
[4] The compound according to [3], wherein the carboxylic acid is naturally-occurring carboxylic acid.
[5] The compound according to any one of [1] to [4], wherein the organic acid is any one of carboxylic acid, hydroxy acid, and sulfonic acid.
[6] The compound according to any one of [1] to [5], wherein the compound has an average particle diameter of 0.01 to 100 μm.
[7] The compound according to any one of [1] to [6] used as a colorant for an ink, a toner, or a coating material.

### Advantageous Effects of Invention

The present invention can provide a compound with a high biomass ratio (preferably a compound with a biomass ratio of 100%) obtained by using a natural pigment and having excellent color developability and light resistance.

### DESCRIPTION OF EMBODIMENTS

Hereinafter, the present invention will be described in detail. The following description of components is an example that describes the present invention, and the present invention is not limited to details of the description.

### (Compound)

In a compound of the present invention, a natural pigment is bound to an organic acid.

The compound of the present invention is a compound with a high biomass ratio (preferably a compound with a biomass ratio of 100%) obtained by using a natural pigment and having excellent color developability and light resistance.

The biomass ratio refers to the weight ratio of a component derived from biomass.

The compound of the present invention is preferably a natural pigment multimer including repetition of the natural pigment bound to the organic acid.

In the compound of the present invention, the pigment during coloring has a particle shape. The compound of the present invention can be preferably used for a coloring material of an ink, a toner, or a coating material as a pigment.

The inventors of the present invention have intensively studied a compound with a high biomass ratio obtained by using a natural pigment and found that compounds described in two embodiments including (1) a compound in which a natural pigment of curcumin is bound to an organic acid, the compound having a number average molecular weight (Mn) falling within a specific range (hereinafter the compound is referred to as a “compound in a first embodiment”) and (2) a compound in which a specific natural pigment is bound to an organic acid (hereinafter the compound is referred to as a “compound in a second embodiment”) are a compound having excellent color developability and light resistance.

The compound of the present invention is classified into the compound in the first embodiment and the compound in the second embodiment and the natural pigment and the organic acid that are raw materials used for the compounds will be described below.

### <Compound in First Embodiment>

In the compound in the first embodiment of the present invention, a natural pigment of curcumin is bound to an organic acid. The compound has a number average molecular weight (Mn) of 400 to 4,950.

The inventors of the present invention have investigated a compound in which curcumin is used as a natural pigment, and the natural pigment of the curcumin is bound to an organic acid, and as a result found that an increase in molecular weight deteriorates color developability (especially chroma) and light resistance. The inventors have found that a compound having a molecular weight more than a specific value cannot be effectively used in practical terms as a coloring material used for an ink, a toner, or a coating material. Among compounds in which a natural pigment of curcumin is bound to an organic acid, the compound of the present invention having a number average molecular weight defined within a specific range has excellent color developability and light resistance. The compound of the present invention can be effectively used as a coloring material for an ink, a toner, or a coating material.

### <<Curcumin>>

Curcumin used as the raw material for the compound in the first embodiment of the present invention has a diol structure. Curcumin can be bound to an organic acid through an ester bond.

### <<Organic Acid>>

An organic acid used as the raw material for the compound in the first embodiment of the present invention is not particularly limited as long as it can bind to curcumin as the natural pigment to form a multimer of the natural pigment, and can be appropriately selected according to the purpose.

The organic acid used in the present invention is not particularly limited and is preferably an organic acid that can easily bind to an OH group in curcumin through an ester bond.

The organic acid used in the present invention is not particularly limited. Examples thereof include carboxylic acid, hydroxy acid, and sulfonic acid.

From the viewpoint of binding the organic acid to curcumin as the natural pigment to form a multimer of the natural pigment, the organic acid used in the present invention preferably has at least one carboxylic acid group. Therefore, the organic acid is preferably carboxylic acid or hydroxy acid.

Examples of the carboxylic acid include fatty acid, aromatic carboxylic acid, dicarboxylic acid, tricarboxylic acid, and polycarboxylic acid. Examples of the hydroxy acid include aliphatic hydroxy acid and aromatic hydroxy acid.

Examples of the fatty acid include formic acid, acetic acid, propionic acid, butyric acid, valeric acid, caproic acid, enanthic acid, caprylic acid, pelargonic acid, capric acid, lauric acid, myristic acid, pentadecylic acid, palmitic acid, margaric acid, stearic acid, acrylic acid, methacrylic acid, oleic acid, linoleic acid, and linolenic acid.

Examples of the aromatic carboxylic acid include salicylic acid, gallic acid, and benzoic acid.

Examples of the dicarboxylic acid include oxalic acid, malonic acid, succinic acid, glutaric acid, adipic acid, pimelic acid, suberic acid, azelaic acid, sebacic acid, phthalic acid, isophthalic acid, terephthalic acid, 4,4′-diphenyldicarboxylic acid, maleic acid, fumaric acid, citraconic acid, mesaconic acid, muconic acid, dimer acid, aspartic acid, aldaric acid, itaconic acid, oxaloacetic acid, and glutamic acid.

Examples of the tricarboxylic acid include aconitic acid, 1,3,5-benzenetricarboxylic acid, and propane-1,2,3-tricarboxylic acid.

Examples of the polycarboxylic acid include an acrylic acid polymer, an acrylic acid-maleic acid copolymer, and an acrylic acid-maleic anhydride copolymer.

Examples of the aliphatic hydroxy acid include glycolic acid, lactic acid, tartronic acid, glyceric acid, hydroxybutyric acid, tartaric acid, malic acid, citric acid, ricinoleic acid, and shikimic acid.

Examples of the aromatic hydroxy acid include vanillic acid, phloretic acid, coumaric acid, caffeic acid, ferulic acid, and sinapinic acid.

The organic acid used in the present invention is preferably a carboxylic acid or hydroxy acid having at least one or more carboxylic acid groups, and more preferably a carboxylic acid or hydroxy acid having two or more carboxylic acid groups. As the number of carboxylic acid groups in the organic acid is larger, the number of reactive sites capable of being bound to the natural pigment is larger, and a compound having higher fastness properties can be obtained.

From the viewpoint of easily obtaining a natural pigment multimer compound having higher crystallinity in which a structure is controlled in terms of using an organic acid as a linker for binding the organic acid to curcumin as the natural pigment to form a multimer of the natural pigment, an organic acid having two carboxylic acid groups is further preferred, and the dicarboxylic acid is particularly preferred.

When the natural pigment is bound to the organic acid through an ester bond to form a multimer, of the dicarboxylic acid, one or more selected from the group consisting of oxalic acid, malonic acid, succinic acid, glutaric acid, adipic acid, pimelic acid, suberic acid, azelaic acid, sebacic acid, phthalic acid, isophthalic acid, terephthalic acid, 4,4′-diphenyldicarboxylic acid, maleic acid, fumaric acid, citraconic acid, mesaconic acid, muconic acid, and dimer acid are the most preferred from the viewpoint of easily obtain a natural pigment multimer compound having higher crystallinity.

When naturally-occurring carboxylic acid is used as the organic acid used in the present invention, a compound with a biomass ratio of 100% can be obtained by binding the organic acid to the natural pigment. Therefore, from the viewpoint of the global environment, living organisms, and safety, the naturally-occurring carboxylic acid is more preferred.

Examples of the naturally-occurring carboxylic acid include succinic acid, sebacic acid, glycolic acid, lactic acid, glyceric acid, tartaric acid, malic acid, citric acid, ricinoleic acid, and fumaric acid.

From the viewpoint of obtaining a compound having excellent color developability and light resistance, it is important that the number average molecular weight (Mn) of the compound in the first embodiment of the present invention is 400 to 4,950 as described above. From the viewpoint of hue, chroma, and fastness properties, it is preferably 600 to 4,950, and more preferably 800 to 4,000. From the viewpoint of obtaining a compound having excellent color developability and light resistance, the weight average molecular weight (Mw) of the compound in the first embodiment of the present invention is preferably 400 to 10,000, and more preferably 800 to 9,000.

The molecular weight of the compound of the present invention can be determined as follows.

### <Method for Determining Molecular Weight>

The number average molecular weight (Mn) and weight average molecular weight (Mw) of the compound of the present invention refer to the number average molecular weight (Mn) and weight average molecular weight (Mw), respectively, determined by measurement through gel permeation chromatography (GPC) using chloroform as a solvent and calculation in terms of polystyrene. If the measurement using chloroform as a solvent cannot be performed, dimethylformamide is used. If the measurement using dimethylformamide cannot be performed, tetrahydrofuran is used. If the measurement using tetrahydrofuran cannot be performed, hexafluoroisopropanol is used.

### <Compound in Second Embodiment>

In the compound in the second embodiment of the present invention, at least one or more types of natural pigments selected from alizarin, carminic acid, lac dye or laccainic acid, capsanthin or capsicum pigment, Safflomin or Carthamus yellow pigment, shisonin or Perilla pigment, and Xanthomonasin or Monascus pigment is bound to an organic acid.

The inventors of the present invention have investigated a compound using a natural pigment, and as a result found that a compound in which at least one or more types of natural pigments selected from the above-mentioned specific natural pigments is bound to an organic acid has excellent color developability and light resistance. The compound of the present invention in which the specific natural pigment is bound to an organic acid can be effectively used as a coloring material for an ink, a toner, or a coating material.

### <<Specific Natural Pigment>>

A natural pigment used as a raw material for the compound in the second embodiment of the present invention is selected from alizarin, carminic acid, lac dye or laccainic acid, capsanthin or capsicum pigment, Safflomin or Carthamus yellow pigment, shisonin or Perilla pigment, and Xanthomonasin or Monascus pigment.

The natural pigments can be bound to an organic acid through an ester bond, for example.

### <<Organic Acid>>

An organic acid used as the raw material for the compound in the second embodiment of the present invention is the same as the organic acid used as the raw material for the compound in the first embodiment of the present invention. That is, an organic acid that is the same as the organic acid described in <<Organic Acid>> in <Compound in First Embodiment> described above can be used.

From the viewpoint of obtaining a compound having excellent color developability and light resistance, the number average molecular weight (Mn) of the compound in the second embodiment of the invention of the present application is preferably 300 to 50,000, more preferably 300 to 30,000, and particularly preferably 300 to 20,000. From the viewpoint of obtaining a compound having excellent color developability and light resistance, the weight average molecular weight (Mw) of the compound in the second embodiment of the invention of the present application is preferably 300 to 100,000, more preferably 300 to 75,000, and particularly preferably 300 to 50,000.

### <Method for Producing Compound>

The compound of the present invention (when a subject is both the compound in the first embodiment and the compound in the second embodiment without discriminating the compound in the first embodiment from the compound in the second embodiment, they may be referred to as “the compound of the present invention”) can be obtained by reacting the natural pigment with the organic acid to form a bond between the natural pigment and the organic acid. When a bond between the natural pigment and the organic acid is formed, a compound including a natural pigment multimer in which the natural pigment is repeated can be obtained.

Examples of the bond include an ester bond.

In a preferable embodiment, examples of the method for producing the compound of the present invention include a production method in which a hydroxy group in the natural pigment and a carboxylic acid group in the organic acid are subjected to an ester condensation reaction to form a bond between the natural pigment and the organic acid.

In a more preferable embodiment, examples of the method include a production method in which a diol compound as the natural pigment and dicarboxylic acid as the organic acid are subjected to an ester condensation reaction to form a bond between the natural pigment and the organic acid.

The method for producing the compound of the present invention can be achieved, for example, by an ester condensation reaction between the diol compound and the dicarboxylic acid. As the dicarboxylic acid used in this case, a dicarboxylic acid may be used in a free form. In addition, a dicarboxylic acid may be used in the form of dicarboxylic acid derivative, such as a dicarboxylic acid ester, dicarboxylic anhydride, and dicarboxylic acid chloride.

In a preferable embodiment, examples of the method for producing the compound of the present invention include a method for producing the compound by, using a dicarboxylic acid chloride as the organic acid, an ester reaction between the dicarboxylic acid chloride as the organic acid and a diol compound as the natural pigment. In this case, the compound can be produced by adopting a method for distilling hydrochloric acid produced in the presence of a solvent at a low temperature or neutralizing the hydrochloric acid with a basic compound. This reaction temperature can be appropriately selected according to the purpose and is preferably −80 to 100° C., more preferably −80 to 60° C., further preferably −20 to 20° C., and particularly preferably −5 to 10° C.

In the case of using a solvent, any solvent that is not reacted with a substrate can be used. A halogenated hydrocarbon such as dichloromethane, chloroform, or tetrachloroethane, an aromatic hydrocarbon such as benzene, toluene, or xylene, an ether such as tetrahydrofuran, dioxane, or dimethoxyethane, a ketone such as acetone, methyl ethyl ketone, methyl isobutyl ketone, or cyclohexanone, an ester such as ethyl acetate or butyl acetate, a nitrile such as acetonitrile, an amide such as N,N-dimethylacetamide or N-methyl-2-pyrrolidone, or the like can be used.

In a preferable embodiment, the method for producing the compound of the present invention when the natural pigment is curcumin includes a method for producing a multimer of curcumin by a reaction of a curcumin pigment represented by the following formula (i) with at least one dicarboxylic acid dichloride selected from the group consisting of succinic acid dichloride, adipic acid dichloride, sebacic acid dichloride, fumaric acid dichloride, terephthalic acid dichloride, and biphenyl dicarboxylic acid dichloride represented by the following formula (ii).

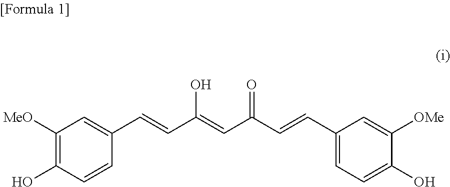 [SMILES: COc1cc(/C=C/C(=O)/C=C(O)/C=C/c2ccc(O)c(OC)c2)ccc1O]

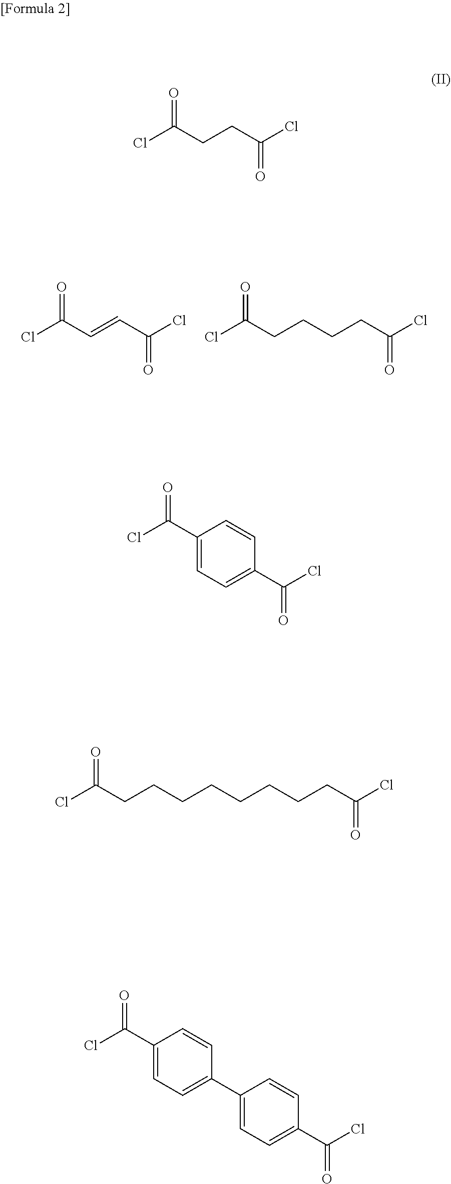

For example, the mixing ratio by mole of the natural pigment to the organic acid is preferably 1:0.1 to 1:10, and more preferably 1:0.5 to 1:1.

By the ester condensation reaction described above, an insoluble lake compound is precipitated, and thus the compound is subjected to solid-liquid separation by a publicly known method, and if necessary, cleaned. Examples of a method of solid-liquid separation include suction filtration, pressure filtration, filter press, spray-drying, decantation, and centrifugal separation. Examples of a cleaning solution include water and a hydrophilic solvent such as an alcohol.

When the raw material is unreacted and remains, the unreacted raw material is removed by this cleaning process. Subsequently, powder after the solid-liquid separation or cleaning is dried by a publicly known method, to obtain an insoluble compound (pigment).

### <Characteristics of Compound>

The compound of the present invention exhibits excellent color developability (chroma) and is excellent in light resistance.

For example, the compound of the present invention including a multimer of curcumin obtained by binding the organic acid to curcumin exhibits excellent chroma and light resistance as described in the following Examples.

### <<Structure of Compound>>

In a preferable embodiment, examples of the compound of the present invention include a compound having a structure represented by the following formula (I) or (II).

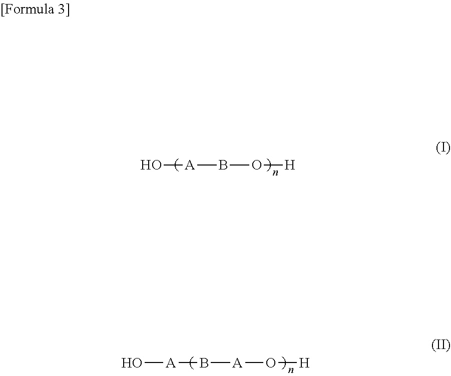

(In the formula (I) or (II), A is a moiety derived from the natural pigment, B is a moiety derived from the organic acid, and n is 1 or more.)

In a preferable embodiment of the compound of the present invention, examples of the compound having a structure represented by the formula (I) include a compound having a structure represented by the following formula (Ia), and examples of the compound having a structure represented by the formula (II) include a compound having a structure represented by the following formula (IIa).

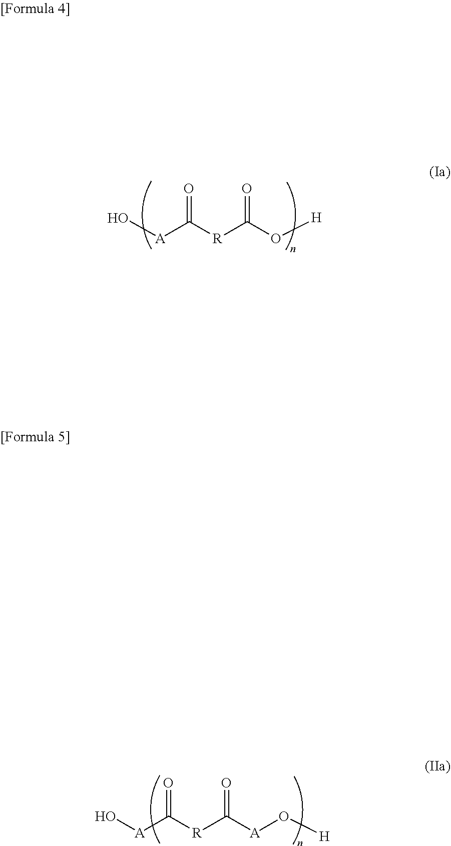

(In the formula (Ia) or (IIa), A is a moiety derived from the natural pigment, R is a hydrocarbon group, and n is 1 or more.)

In a further preferable embodiment of the compound of the present invention, examples of the compound having a structure represented by the formula (Ia) include a compound having a structure represented by the following formula (Ib), and examples of the compound having a structure represented by the formula (IIa) include a compound having a structure represented by the following formula (IIb).

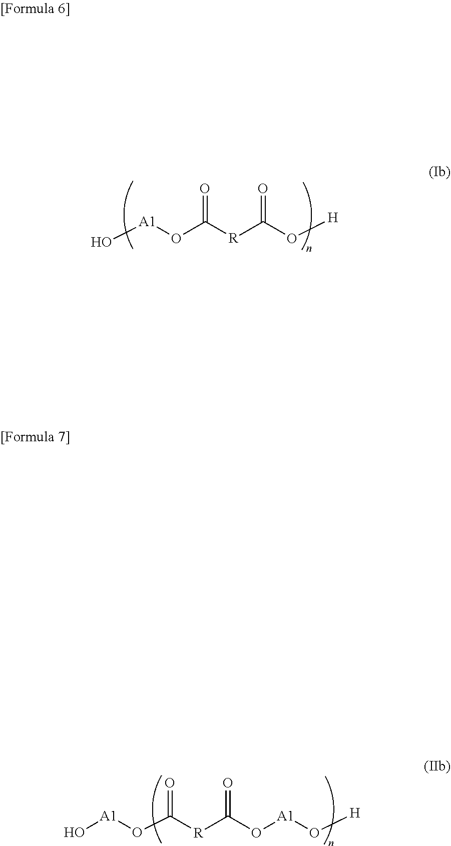

(In the formula (Ib) or (IIb), A1 is a residue of the moiety derived from the natural pigment, excluding a diol moiety at the end, R is a hydrocarbon group, and n is 1 or more.)

In a further preferable embodiment, when the natural pigment is curcumin, examples of the compound of the present invention include a compound having a structure represented by the following formula (III).

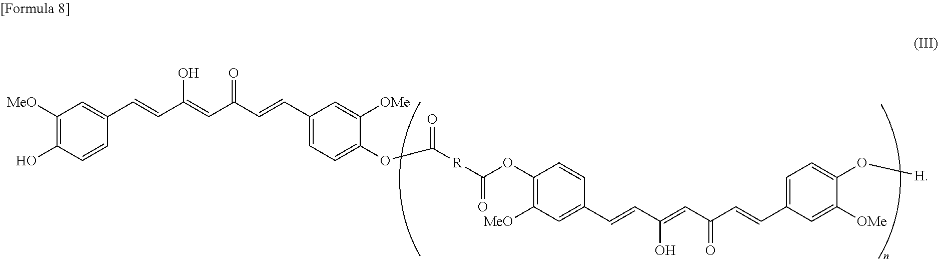

(In the formula (III), Me is a methyl group, R is a hydrocarbon group, and n is 1 or more.)

Examples of R (hydrocarbon group) in the formulae (Ia), (IIa), (Ib), (IIb), and (III) include a linear hydrocarbon group, a branched hydrocarbon group, and a cyclic hydrocarbon group.

The hydrocarbon group may be a saturated hydrocarbon group or an unsaturated hydrocarbon group. Examples of the hydrocarbon group include a linear saturated hydrocarbon group, a linear unsaturated hydrocarbon group, a cyclic unsaturated hydrocarbon group, and a saturated hydrocarbon group.

For example, the number of carbon atoms in the hydrocarbon group is preferably 2 to 15. When the organic acid is defined to contain dimer acid, the number of carbon atoms is preferably 2 to 36.

Examples of R (hydrocarbon group) in the formulae (Ia), (IIa), (Ib), (IIb), and (III) include at least one group selected from the group consisting of groups represented by the following formula (IV).

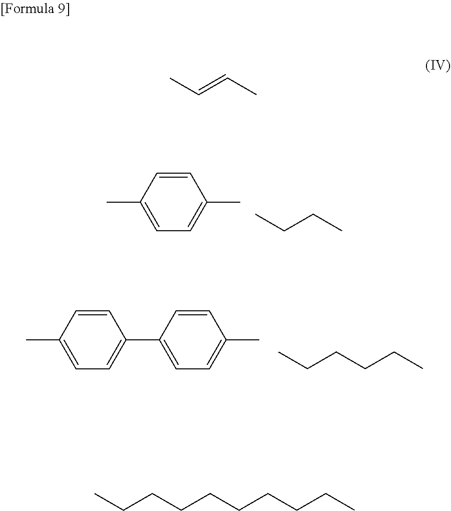

### <Particle Diameter>

The average particle diameter of the compound of the present invention is not particularly limited, and from the viewpoint of color developability and hiding properties during formation of an ink, it is preferably 0.01 to 100 μm and more preferably 0.05 to 50 μm.

The average particle diameter of the compound is an arithmetic mean value determined by photographing particles with a transmission or scanning electron microscope and measuring the longest diameter of 20 particles among the particles.

As described above, the compound of the present invention has excellent color developability and further has excellent light resistance. The compound of the present invention is a compound with a high biomass ratio and is biodegradable in sea water. Therefore, the compound of the present invention can be used as a colorant for an ink, a toner, or a coating material.

The compound of the present invention can be mixed with a material other than the compound of the present invention to prepare a composition (for example, a pigment composition). Thus, the compound of the present invention can be used for an ink, a toner, a coating material, or the like.

Marine biodegradability means decomposition by a microorganism in sea water. Specifically, the compound of the present invention is added to sea water and stirred for 30 days while being held at 27° C. The weight of the compound before and after a test is measured. For a polyhydroxybutyric acid powder, the same operation is performed. The weight decrease rate of each of the compound and the polyhydroxybutyric acid is calculated. It is presumed that when the relative weight decrease rate of the compound relative to a weight decrease rate of polyhydroxybutyric acid of 100% is 5% or more, the compound has biodegradability in sea water, that is, marine biodegradability. Since a higher decomposition rate in sea water decreases a burden on the environment, the relative weight decrease rate is preferably 10% or more, and more preferably 15% or more.

### (Pigment Composition)

The compound of the present invention can be mixed with other materials to prepare a pigment composition.

### <Resin>

In the pigment composition, a resin may be mixed with the compound of the present invention. Examples of the resin usable in the present invention include a thermosetting resin and a thermoplastic resin.

The thermosetting resin is a resin having a property that can be changed into substantial insolubility and infusibility during curing by means such as heating, radiation, or catalysis. Examples of the thermosetting resin include a phenol resin, a urea resin, a melamine resin, a benzoguanamine resin, an alkyd resin, an unsaturated polyester resin, a vinyl ester resin, a diallyl terephthalate resin, an epoxy resin, a silicone resin, a urethane resin, a furan resin, a ketone resin, a xylene resin, a thermosetting polyimide resin, a benzoxazine resin, an active ester resin, an aniline resin, a cyanate ester resin, and a styrene-maleic anhydride (SMA) resin. One or two or more types of the thermosetting resins may be used in combination.

The thermoplastic resin is a resin that can be melt-molded under heating. Examples of the thermoplastic resin include a polyethylene resin, a polypropylene resin, a polystyrene resin, a rubber-modified polystyrene resin, an acrylonitrile-butadiene-styrene (ABS) resin, an acrylonitrile-styrene (AS) resin, a polymethyl metharylate resin, an acrylic resin, a polyvinyl chloride resin, a polyvinylidene chloride resin, a polyethylene terephthalate resin, an ethylene-vinyl alcohol resin, a cellulose acetate resin, an ionomer resin, a polyacrylonitrile resin, a polyamide resin, a polyacetal resin, a polybutylene terephthalate resin, a polylactic acid resin, a polyphenylene ether resin, a modified polyphenylene ether resin, a polycarbonate resin, a polysulfone resin, a polyphenylene sulfide resin, a polyetherimide resin, a polyethersulfone resin, a polyarylate resin, a thermoplastic polyimide resin, a polyamideimide resin, a polyetherether ketone resin, a polyketone resin, a liquid crystal polyester resin, a fluororesin, a syndiotactic polystyrene resin, and a cyclic polyolefin resin. One or two or more types of the thermoplastic resins may be used in combination.

The resin used in the present invention may be mixed as a resin for molding or may be mixed as a varnish. The resin used in the present invention may be mixed for expected effects of further additives, such as a dispersant, a surface modifier, a surfactant, and a film toughener.

When the resin is mixed as a varnish, a publicly known resin can be used. Examples of the resin mixed as a varnish include a phenol resin, a petroleum resin, a rosin-modified phenol resin, a petroleum resin-modified phenol resin, a rosin ester, an alkyd resin, a modified alkyd resin, a rosin-modified maleic acid resin, a Gilsonite resin, a urethane resin, and an epoxy resin.

When the resin is mixed as a dispersant or a surface modifier, a publicly known resin can be used. Examples of the resin mixed as a dispersant or a surface modifier include cellulose; cellulose derivatives such as an alkyl cellulose (ethyl cellulose, methyl cellulose, etc.), a hydroxyalkyl cellulose (hydroxymethyl cellulose, hydroxyethyl cellulose, hydroxypropyl cellulose, hydroxypropylmethyl cellulose, hydroxyethylmethyl cellulose, etc.), a carboxyalkyl cellulose (carboxymethyl cellulose, carboxyethyl cellulose, etc.), and cellulose acetate; an alkyl allyl polyether alcohol, a sucrose ester of a fatty acid, a polyoxyethylene alkyl ether, a polyoxyethylene hydrogenated castor oil, a propylene glycol ester of a fatty acid, a lauryl sulfonic acid salt, a stearic acid salt, a sorbitan ester of a fatty acid, a polyethylene glycol ester of a fatty acid, a polyoxyethylene glycerol ester of a fatty acid, a glycerol ester of a fatty acid, a polyoxyethylene polyoxypropylene glycol, a polyoxyethylene sorbitol ester of a fatty acid, a polyoxyethylene alkyl allyl ether, an alkyl allyl sulfonic acid salt, a polyoxyethylene sorbitan ester of a fatty acid, and mixtures thereof.

### <Solvent>

In the pigment composition, a solvent may be further mixed. The solvent may be used as a dilution solvent or may be mixed for expected effects of various additives, such as a varnish or dampening water.

The solvent can be used according to the application without particular limitation. Examples of the solvent include water, an aqueous solvent, an organic solvent, and a liquid organic polymer. One type of the solvent may be used alone or a plurality of types of the solvents may be used in combination.

Examples of the organic solvent include ketones such as acetone, methyl ethyl ketone (MEK), and methyl isobutyl ketone (MIBK), cyclic ethers such as tetrahydrofuran (THE) and dioxolane, esters such as methyl acetate, ethyl acetate, and butyl acetate, aromatic compounds such as toluene and xylene, paraffin-based solvents such as n-pentane, isopentane, n-hexane, 2-methylpentane, n-heptane, n-octane, and trimethylpentane, naphthene-based solvents such as cyclohexane, cyclohexylmethane, octadecylcyclohexane, and methylisopropylcyclohexane, alcohols such as carbitol, cellosolve, methanol, isopropanol (2-propanol), butanol, and propylene glycol monomethyl ether; mineral spirit, and petroleum naphtha.

As the solvent, for example, a nondrying oil such as castor oil, groundnut oil, or olive oil, a semidrying oil such as soybean oil, cottonseed oil, rapeseed oil, sesame oil, or corn oil, a drying oil such as linseed oil, perilla oil, or tung oil, or a vegetable-derived oil such as a reclaimed vegetable oil or a vegetable ester can be used.

### <Other Mixing Material>

The pigment composition may contain a mixing material such as an antiskinning agent, a viscosity adjuster, a film toughener, a dispersant, a stain preventing agent, an emulsification adjuster, or an antioxidant, if necessary. As the mixing material, a conventionally known material can be suitably used.

### (Molded Body)

When the pigment composition contains a resin for molding, the pigment composition can be molded to obtain a molded body. As a molding method, a conventionally known method may be used, and the method may be appropriately selected according to the application. The shape of the molded body is not limited and may be any shape according to the purpose, such as a flat plate, a sheet shape, or a three-dimensional shape wholly or partially having a curvature.

For example, when a plate-shaped or sheet-shaped product is produced, a method for producing the molded body is generally an extrusion molding method, but the method may be flat pressing. In addition, a profile extrusion molding method, a blow molding method, a compression molding method, a vacuum molding method, an injection molding method, or the like can be used. When a film-shaped product is produced, a melt extrusion method or a solution casting method can be used. When a melt molding method is used, for example, blown film molding, cast molding, extrusion lamination molding, calender molding, sheet molding, fiber molding, blow molding, injection molding, rotation molding, coating molding, or the like can be used. For a resin to be cured by heat or an active energy ray, a variety of curing methods using heat or an active energy ray can be used to produce a molded body.

When the resin composition is liquid, molding can be achieved by coating. Examples of a coating method include a spraying method, a spin coating method, a dip method, a roll coating method, a blade coating method, a doctor roll method, a doctor blade method, a curtain coating method, a slit coating method, a screen printing method, and an inkjet method.

### (Ink (Printing Ink))

The pigment composition can be used for an ink. An ink containing the pigment composition contains a resin and/or an organic solvent in addition to the compound of the present invention. Since the compound of the present invention has excellent color developability and light resistance, the use of the compound as a colorant for an ink makes vivid printing possible.

In the case of using the pigment composition for an ink, a printed product in which printing with the ink is performed can be obtained. A printing substrate is not particularly limited, and examples thereof include paper, wood, plastics, inorganic substances such as metal and mineral, and composites thereof. The shape of the substrate is not limited and may be any shape according to the purpose, such as a flat plate, a sheet shape, or a three-dimensional shape wholly or partially having a curvature. The hardness, thickness, and the like of the substrate are not limited.

A printing ink using the compound of the present invention is not particularly limited as long as the compound of the present invention as described above is used, and a printing ink with a publicly known composition can be obtained.

Since the compound of the present invention has excellent color developability, the printing ink makes vivid printing possible. Therefore, the printing ink using the compound of the present invention can be used suitably as various types of printing inks used in offset printing, gravure printing, flexographic printing, screen-printing, and the like. In particular, the printing ink can be used suitably as an offset lithographic printing ink for offset lithographic printing or a liquid printing ink usable for gravure printing or flexographic printing.

### <Offset Lithographic Printing Ink>

An offset printing ink refers to an ink used in lithographic printing (lithographic printing using dampening water and dry lithographic printing using no dampening water), relief printing, intaglio printing, permeographic printing, or a variety of printing procedures combined with a transfer (offset) procedure in which the ink attached to the plate of the printing is transferred to an intermediate transferred body such as a blanket, followed by printing on an object to be printed.

The offset lithographic printing ink is produced by mixing the compound of the present invention, a resin varnish for a printing ink, an organic solvent, a vegetable oil such as soybean oil or an esterified vegetable oil, a drying inhibitor, a drier, an abrasion resistance improving agent, and the like and milling the mixture with a roll mill, resulting in dispersion.

### <Liquid Printing Ink>

A liquid printing ink used as a gravure printing ink or a flexographic printing ink is broadly classified into an organic solvent-containing liquid printing ink containing as a main solvent an organic solvent and an aqueous liquid printing ink containing as a main solvent water. The compound of the present invention can be used for both the organic solvent-containing liquid printing ink and the aqueous liquid printing ink.

### <<Organic Solvent-Containing Liquid Printing Ink>>

For the organic solvent-containing liquid printing ink, a mixture containing the compound of the present invention, a binder resin, an organic solvent, a dispersant, a defoamer, and the like is dispersed with a disperser, to obtain a dispersed body. To the thus obtained dispersed body, a resin, an organic solvent, and if necessary, an additive such as a leveling agent are added, stirred, and mixed, to obtain the organic solvent-containing liquid printing ink.

### <<Aqueous Liquid Printing Ink>>

For the aqueous liquid printing ink, a mixture containing the compound of the present invention, a binder resin, an aqueous medium, a dispersant, a defoamer, and the like is dispersed with a disperser, to obtain a dispersed body. To the thus obtained dispersed body, a resin, an aqueous medium, and if necessary, an additive such as a leveling agent are added, stirred, and mixed, to obtain the aqueous liquid printing ink.

Hereinafter, the compound of the present invention can be suitably used as a colorant for an ink, a toner, or a coating material.

### EXAMPLES

Hereinafter, the present invention will be described specifically with reference to Examples, but the present invention is not limited to the following Examples unless the present invention departs from the gist thereof. Unless otherwise indicated, “part (s)” and “%” in each Example are based on mass.

### <Method for Producing Pigment 1>

82.8 parts by mass of natural pigment and 1,599 parts by mass of tetrahydrofuran (available from Kanto Chemical Co., Inc., dehydrated, containing no stabilizer) were put in a 100-mL two-neck flask, a gas in the flask was purged with argon, and the mixture was stirred for 5 minutes while cooling to 0° C. in an ice bath. 22.7 parts by mass of triethylamine (available from FUJIFILM Wako Pure Chemical Corporation, guaranteed reagent) was added dropwise, and the mixture was stirred at 0° C. for further 5 minutes. Next, 17.2 parts by mass of organic acid was slowly added dropwise. After completion of the dropwise addition, the mixture was stirred at 0° C. for 6 hours. Subsequently, the solvent was distilled off with an evaporator, and the residue was suspended with 1, 780 parts by mass of methanol (available from KISHIDA CHEMICAL Co., Ltd., first grade) and cleaned. Solid-liquid separation was then performed by suction filtration using filter paper (available from ADVANTEC Co., Ltd., qualitative filter paper No. 1). The solid obtained by the separation was dried in vacuum at 50° C., to obtain powder.

### Example 1

Powder of natural pigment multimer compound was obtained by a method in Method for Producing Pigment 1 using curcumin (available from FUJIFILM Wako Pure Chemical Corporation, guaranteed reagent) as a natural pigment and fumaric acid chloride (fumaryl chloride; available from Tokyo Chemical Industry Co., Ltd.) as an organic acid.

The mixing amounts of the components used in Example 1 are listed in Table 1 below. In Table 1, the unit of the mixing amount is part by mass.

### Examples 2 to 8

Like in Example 1, powder of natural pigment multimer compound was obtained in the same manner as in Example 1 except that the mixing amounts of natural pigment (curcumin) and organic acid listed in Table 1 were changed to the mixing amounts listed in Table 1.

### Example 9

Like in Example 1, powder of natural pigment multimer compound was obtained in the same manner as in Example 1 except that the natural pigment was changed to alizarin and the mixing amounts of natural pigment (alizarin) and organic acid were changed to the mixing amounts listed in Table 1. The obtained powder of natural pigment multimer compound developed pale yellow.

### Comparative Examples 1 and 2

Like in Example 1, powder of natural pigment multimer compound was obtained in the same manner as in Example 1 except that the mixing amounts of natural pigment (curcumin) and organic acid listed in Table 1 were changed to the mixing amounts listed in Table 1.

TABLE 1

| | | | | | | | | | | | Comparative | |
|---|---|---|---|---|---|---|---|---|---|---|---|---|
| | | Example | | | | | | | | | Example | |
| | | 1 | 2 | 3 | 4 | 5 | 6 | 7 | 8 | 9 | 1 | 2 |
| Natural | Curcumin | 82.8 | 82.6 | 80.1 | 75.5 | 70.0 | 67.0 | 78.4 | 72.5 | | 65.8 | 60.6 |
| pigment | Alizarin | | | | | | | | | 75.6 | | |
| Organic | Fumaric acid | 17.2 | | | | | | | | | | |
| acid | Succinic acid | | 17.4 | | | | | | | 24.4 | | |
| | Adipic acid | | | 19.9 | | | | | | | | |
| | Sebacic acid | | | | 24.5 | 30.0 | 33.0 | | | | 34.2 | 39.4 |
| | Terephthalic | | | | | | | 21.6 | | | | |
| | acid | | | | | | | | | | | |
| | 4,4′-biphenyl | | | | | | 27.5 | | 27.5 | | | |
| | dicarboxylic | | | | | | | | | | | |
| | acid | | | | | | | | | | | |

| | | | | | | | | | | | |
|---|---|---|---|---|---|---|---|---|---|---|---|
| Tetrahydrofuran | 1599 | 1595 | 1547 | 1458 | 1352 | 1293 | 1514 | 1400 | 1791 | 1271 | 1171 |
| Triethylamine | 22.7 | 22.7 | 22.0 | 20.7 | 25.8 | 24.6 | 21.5 | 19.9 | 51.0 | 25.9 | 33.3 |

### <Method for Determining Molecular Weight of Multimer Compound>

The molecular weight of a multimer compound sample was determined in terms of polystyrene under the following conditions by gel permeation chromatography (GPC).
Device name: LC-20000Plus series manufactured by JASCO Corporation
Column: a guard column of “Showdex GPC K-G 4A” and two columns “Showdex GPC K-804L” were connected (all manufactured by Showa Denko K.K.).
Column oven temperature: 40° C.
Detector: RI-2031Plus manufactured by JASCO Corporation and UV-2070Plus manufactured by JASCO Corporation
Eluent: chloroform
GPC sample concentration: 1 g/L
Flow rate: 0.5 mL/min
Standard sample: polystyrene standard sample STANDARD SM-105 available from Showa Denko K.K.

### <Preparation of Offset Lithographic Printing Ink>

### <<Preparation of Resin Varnish for Offset Lithographic Printing Ink>>

44 parts by mass of rosin-modified phenol resin (weight average molecular weight: 45,000) and 15 parts by mass of soybean oil were prepared, the temperature was increased to 220° C. under nitrogen flow, the mixture was stirred under heating for 1.5 hours, 39.7 parts by mass of AF solvent No. 7 (petroleum-based solvent: available from JXTG Energy Corporation) was added, and the mixture was stirred for 30 minutes and then cooled to 140° C.

After the cooling, 1.0 part by mass of aluminum ethylacetoacetate-diisopropylate solution diluted to 50% with AF solvent No. 7 was added, the temperature was increased to 160° C., and the mixture was stirred under heating for 1.0 hour and then cooled to 140° C. 0.3 parts by mass of BHT (available from Honshu Chemical Industry Co., Ltd.) was added and stirred, to obtain a resin varnish for offset lithographic printing ink.

### <<Preparation of Offset Lithographic Printing Ink>>

The following components were milled at the following mixing ratio with a three-roll mill, to obtain an offset lithographic printing ink.

### [Mixing Amount of Offset Lithographic Printing Ink]

Resin varnish for offset lithographic printing ink: 65 parts
Natural pigment multimer compound: 16 parts
AF solvent No. 7: 19 parts

An offset lithographic printing ink was prepared by the method described in <<Preparation of Offset Lithographic Printing Ink>> using the natural pigment multimer compound listed in Table 1.

### <Preparation of Printing Ink-Developed Body>

The offset lithographic printing ink was applied to a topcoat paper with a spatula and then dried with a dryer, to obtain a developed body.

### <Measurement of Hue of Printing Ink-Developed Body>

The hue (L* value, a* value, and b* value) of the printing ink-developed body was measured with a spectrophotometer (SpectroEye manufactured by X-rite) in the CIELAB color space under conditions of an observation light source D50 and an observation visual field of 2°.

Using the resulting measured values, a chroma C* was calculated by the following expression.

C*=√((a*)\hat{ }2+(b*)\hat{ }2)

### <Light Resistance Test>

The produced printing ink-developed body was subjected to a light resistance test with Atlas Ci3000 Weather-Ometer manufactured by Toyo Seiki Seisaku-sho, Ltd., under conditions of an irradiance of 40 W/m², a black panel temperature of 63° C., 50% RH, and an exposure time of 15 hours in accordance with “Accelerated weathering and exposure to artificial radiation (Exposure to filtered xenon-arc radiation)” defined in JIS K 5600:2008. For the developed body before and after the test, the hue was determined by the aforementioned method. Light resistance was evaluated as follows using a color difference ΔE value (ΔE=√{(ΔL*\hat{ }2)+(Δa*\hat{ }2)+(Δb*\hat{ }2)}\hat{ }2 between before and after the test; wherein ΔL, Δa, and Δb are differences of the L value, the a value, and the b value, respectively, between before and after the test of the developed body).

### [Evaluation Criteria]

A: ΔE value is 5 or less.
B: ΔE value is more than 5 and 10 or less.
C: ΔE value is more than 10 and 20 or less.
D: ΔE value is more than 20 and 30 or less.
E: ΔE value is more than 30.

### Example 10

For the powders of the natural pigment multimer compounds obtained in Examples 2 to 6 and Comparative Examples 1 and 2, the number average molecular weight Mn, the weight average molecular weight Mw, and the molecular weight distribution (=Mw/Mn) were determined by the method for measuring the molecular weight of the multimer compound described above. The results are listed in Table 2 below.

TABLE 2

| | Number average | Weight average | Molecular weight |
|---|---|---|---|
| | molecular weight | molecular weight | distribution |
| | Mn | Mw | Mw/Mn |
| Example 2 | 1384 | 1952 | 1.41 |
| Example 3 | 1895 | 2760 | 1.46 |
| Example 4 | 2754 | 3969 | 1.44 |
| Example 5 | 3731 | 5855 | 1.57 |
| Example 6 | 4913 | 8185 | 1.67 |
| Comparative | 6117 | 13251 | 2.17 |
| Example 1 | | | |
| Comparative | 7702 | 16749 | 2.17 |
| Example 2 | | | |

### Example 11

Using each of the powders of the natural pigment multimer compounds obtained in Examples 2 to 6 and Comparative Examples 1 and 2 as a pigment, a printing ink-developed body was produced by the methods described in <Preparation of Offset Lithographic Printing Ink> and <Preparation of Printing Ink-Developed Body>, and light resistance was evaluated by the methods described in <<Measurement of Hue of Printing Ink-Developed Body> and <Light Resistance Test>.

The evaluation results of the light resistance test for the offset lithographic printing ink using each of the natural pigment multimer compounds are listed in Table 3 below.

TABLE 3

| | | | | Color | Evalua- |
|---|---|---|---|---|---|
| | Material for | | | measure- | tion of |
| | pigment | | | ment | light |
| | Natural | Organic | Type of | Chroma | resistance |
| | Pigment | acid | printing ink | C* | test |
| Example 2 | Curcumin | Succinic | Offset | 87.7 | A |
| | | acid | lithographic | | |
| | | | printing ink | | |
| Example 3 | Curcumin | Adipic | Offset | 88.7 | B |
| | | acid | lithographic | | |
| | | | printing ink | | |
| Example 4 | Curcumin | Sebacic | Offset | 94.7 | B |
| | | acid | lithographic | | |
| | | | printing ink | | |
| Example 5 | Curcumin | Sebacic | Offset | 92.5 | C |
| | | acid | lithographic | | |
| | | | printing ink | | |
| Example 6 | Curcumin | Sebacic | Offset | 84.5 | C |
| | | acid | lithographic | | |
| | | | printing ink | | |
| Compar- | Curcumin | Sebacic | Offset | 78.3 | E |
| ative | | acid | lithographic | | |
| Example 1 | | | printing ink | | |
| Compar- | Curcumin | Sebacic | Offset | 67.7 | E |
| ative | | acid | lithographic | | |
| Example 2 | | | printing ink | | |

As confirmed from Examples above, the compound of the present invention that is the natural pigment multimer including repetition of the natural pigment bound to the organic acid is a compound with a high biomass ratio having excellent color developability and light resistance.

### <Evaluation of Marine Biodegradability>

To 100 parts by mass of sea water (collected at Akanehama port in Narashino city, Chiba Prefecture) in which a foreign substance was removed using a mesh having an opening of 30 μm, 0.015 parts by mass of natural pigment multimer compound was added, and the mixture was stirred with a magnetic stirrer for 30 days while the water temperature was held at 27° C. After the test, the natural pigment multimer compound was collected by filtration through a membrane filter and dried in vacuum at 60° C. for 24 hours, and the weight thereof was measured. For a polyhydroxybutyric acid powder (available from Sigma-Aldrich), the same operation was performed and the weight after the test was measured. The weight decrease rate and the relative weight decrease rate were calculated by the following expressions (1) to (3), and marine biodegradability was evaluated in accordance with the following criteria.

Weight decrease rate of natural pigment multimer compound=100−(weight of sample after 30 days/weight of sample before test)×100 (1)

Weight decrease rate of polyhydroxybutyric acid=100−(weight of polyhydroxybutyric acid after 30 days/weight of polyhydroxybutyric acid before test)×100 (2)

Relative weight decrease rate=(weight decrease rate of natural pigment multimer compound/weight decrease rate of polyhydroxybutyric acid)×100 (3)

### [Evaluation Criteria]

A: relative weight decrease rate is 15% or more.
B: relative weight decrease rate is 10% or more and less than 15%.
C: relative weight decrease rate is 5% or more and less than 10%.
D: relative weight decrease rate is less than 5%.

### Example 12

For the powders of the natural pigment multimer compounds obtained in Examples 2 and 4, biodegradability in sea water was evaluated by the method described in <Evaluation of Marine Biodegradability>. The results are listed in Table 4.

TABLE 4

| | Evaluation result of marine biodegradability |
|---|---|
| Example 2 | C |
| Example 4 | A |

As confirmed from Examples above, the compound of the present invention that is the natural pigment multimer including repetition of the natural pigment bound to the organic acid has marine biodegradability.

1. A compound wherein a natural pigment of curcumin is bound to an organic acid, the compound having a number average molecular weight (Mn) of 400 to 4,950.

2. A compound wherein at least one or more types of natural pigments selected from alizarin, carminic acid, lac dye or laccainic acid, capsanthin or capsicum pigment, Safflomin or Carthamus yellow pigment, shisonin or Perilla pigment, and Xanthomonasin or Monascus pigment is bound to an organic acid.

3. The compound according to claim 1, wherein the organic acid has at least one or more carboxylic acid groups.

4. The compound according to claim 3, wherein the carboxylic acid is naturally-occurring carboxylic acid.

5. The compound according to claim 1, wherein the organic acid is any one of carboxylic acid, hydroxy acid, and sulfonic acid.

6. The compound according to claim 1, wherein the compound has an average particle diameter of 0.01 to 100 μm.

7. The compound according to claim 1 used as a colorant for an ink, a toner, or a coating material.
